(19) United States
(12) Patent Application Publication
(10) Pub. No.: US 2016/0201616 A1
(43) Pub. Date: Jul. 14, 2016

(54) EXHAUST GAS RECIRCULATION SYSTEM FOR MACHINE

(71) Applicant: Caterpillar Inc., Peoria, IL (US)

(72) Inventors: Adam D. Dye, Peoria, IL (US); Jeffrey J. Ribordy, Chillicothe, IL (US); Derek E. Nieman, Peoria, IL (US)

(73) Assignee: Caterpillar Inc., Peoria, IL (US)

(21) Appl. No.: 15/073,677

(22) Filed: Mar. 18, 2016

(51) Int. Cl. F02M 26/60; F02M 26/41

(52) U.S. Cl. CPC F02M 26/60; F02M 26/41

(57) ABSTRACT

An exhaust gas recirculation (EGR) system is provided. The EGR system includes an engine having an intake manifold. The intake manifold is adapted to receive intake air from an aftercooler. The EGR system also includes an exhaust manifold. The exhaust manifold is adapted to receive exhaust gas from a plurality of cylinders of the engine. The EGR system further includes an EGR line. The EGR line is fluidly coupled between the intake manifold and the exhaust manifold. The EGR system includes an EGR valve disposed in the EGR line. The EGR system also includes a pressure line. The pressure line is coupled between the intake manifold and the EGR valve. The EGR valve is movable to an open position from a closed position, based on an intake pressure communicated to the EGR valve via the pressure line.

### TECHNICAL FIELD

The present disclosure relates to an exhaust gas recirculation system; and more particularly to recirculation of exhaust gases in an engine.

### BACKGROUND

Internal Combustion engines are known to employ an Exhaust Gas Recirculation (EGR) device to reduce NOx emission from the exhaust gases. The EGR device is used to recirculate exhaust gases from an exhaust manifold to an intake manifold of the engine. A combination of the recirculated exhaust gases mixes and intake air is introduced in a combustion chamber of the engine. The introduction of the recirculated exhaust gases decreases combustion temperature, thereby suppressing an amount of NOx in the exhaust gas. The EGR device includes an EGR cooler. Typically, water is used to cool the exhaust gases flowing through the EGR coolers. However, cooling of the exhaust gases using water or other cooling liquids tend to affect durability of multiple components of the engine.

U.S. Pat. No. 6,263,672, hereinafter referred to as the '672 patent, describes an EGR system for an internal combustion engine. The EGR system disclosed in '672 patent includes a turbocharger, restrictor valve, and EGR valve. The restrictor valve is upstream of the turbine of the turbocharger, and restricts the flow of exhaust gas into the turbine. This restriction results in an increase in pressure of the exhaust gas provided to the restrictor valve. The increased pressure exhaust gas is provided to the inlet of an EGR valve which may be actuatable independently of the actuation of the restrictor valve. The restrictor valve may be modulated until exhaust pressure is greater than the pressure of the intake gas. The restrictor valve creates a pressure differential suitable for recirculating a portion of exhaust gas through the EGR valve and into the intake manifold of the engine. The restrictor valve may also be operated without recirculation of exhaust gas, such as during cold starting of a diesel engine so as to increase the load on the engine and decrease the warm-up time of the engine. However, the '672 patent does not disclose a system for controlling the restrictor valve of the EGR system to reduce the NOx emission.

### SUMMARY OF THE DISCLOSURE

In one aspect of the present disclosure, an Exhaust Gas Recirculation (EGR) system is provided. The EGR system includes an engine having an intake manifold. The intake manifold is adapted to receive intake air from an aftercooler, The EGR system also includes an exhaust manifold, The exhaust manifold is adapted to receive exhaust gas from a plurality of cylinders of the engine. The EGR system further includes an EGR line. The EGR line is fluidly coupled between the intake manifold and the exhaust manifold. The EGR system includes an EGR valve disposed in the EGR line. The EGR system also includes a pressure line. The pressure line is coupled between the intake manifold and the EGR valve, The EGR valve is movable to an open position from a closed position, based on an intake pressure communicated to the EGR valve via the pressure line.

Other features and aspects of this disclosure will be apparent from the following description and the accompanying drawings.

### BRIEF DESCRIPTION OF THE DRAWINGS

FIG. 1 is a schematic view of an exemplary machine having an engine system, according to the concepts of the present disclosure;

FIG. 2 is a schematic view of the engine system of FIG. 1 having an engine and an Exhaust Gas Recirculation (EGR) system, according to the concepts of the present disclosure.

FIG. 3 is a schematic view of an EGR valve associated with the EGR system shown in FIG. 2, according to the concepts of the present disclosure; and

FIG. 4 is a flowchart for a process to recirculate some amount of exhaust gases in an intake manifold of the engine, according to the concepts of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

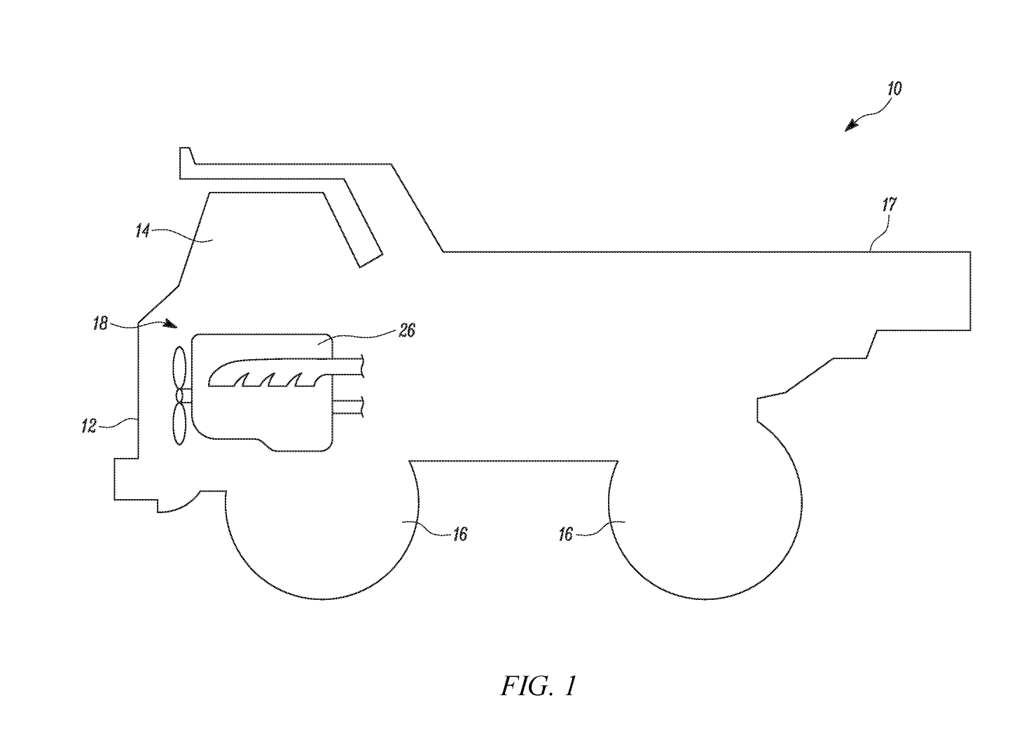

Referring to FIG. 1, an exemplary machine 10 is shown. In an example, the machine 10 may embody a truck, such as a dump truck. Alternatively, the machine 10 may include, but not limited to, a backhoe loader, a skid steer loader, a wheel loader, a motor grader, an excavator, a scraper, an agricultural tractor, a wheel loader, or a haul truck. In another example, the machine 10 may embody a stationary equipment, such as a power generation set. It should be understood that the machine 10 may embody any wheeled or tracked machine associated with mining, agriculture, forestry, construction, and other industrial applications, without any limitations.

The machine 10 includes a frame 12 and an operator station 14 mounted on the frame 12. The machine 10 also includes a number of ground engaging members 16 for propelling the machine 10 over a ground surface. The operator station 14 includes control levers and/or switches for operating and driving the machine 10. The machine 10 may include a dump body 17. The frame 12 pivotally supports the dump body 17 thereon. The machine 10 includes an engine system 18. The engine system 18 provides power to move the machine 10 on the ground surface.

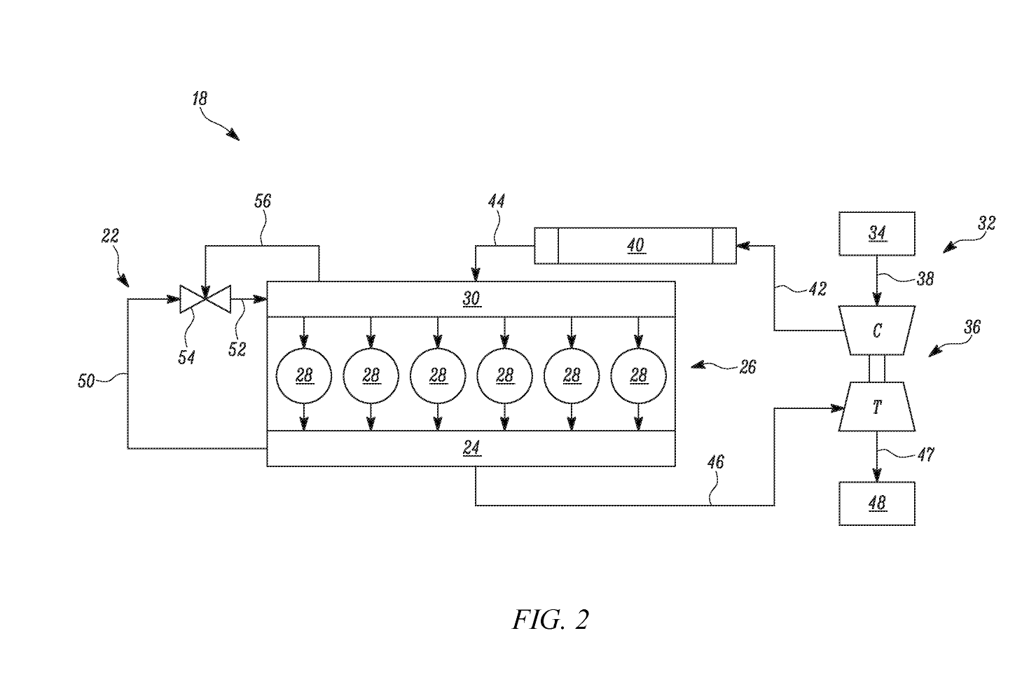

As shown in FIG. 2, the engine system 18 includes an Exhaust Gas Recirculation (EGR) system 22 and an engine 26. The EGR system 22 receives exhaust gases from an exhaust manifold 24 of the engine 26. The engine 26 is mounted on the frame 12 of the machine 10 (see FIG. 1). In an embodiment, the engine 26 may include, for example, a diesel engine, a gasoline engine, a gaseous fuel powered engine such as, a natural gas engine, a combination of known sources of power, or any other type of power source.

Referring to HG. 2, the engine 26 includes a number of cylinders 28. Further, the engine 26 includes an intake manifold 30. The intake manifold 30 receives intake air, which may include traces of recirculated exhaust gases therein, through an air intake system 32. The intake air along with fuel is introduced into the cylinders 28, wherein combustion occurs. Products of combustion may be exhausted from the engine 26, via the exhaust manifold 24, The engine 26 may be of any size, with any number of cylinders, and in any configuration (“V,” in-line, radial, etc.), without limiting the scope of the present disclosure.

Ambient air may be drawn into the engine 26 through an air filter 34 of the air intake system 32. The air intake system 32 of the engine system 18 includes a turbocharger 36, In an example, the turbocharger 36 may be a fixed geometry turbocharger having an exhaust gas driven turbine “T” coupled to an intake air compressor “C”. Alternatively, the turbocharger 36 may be of variable geometry or any other type of turbocharger known in the art. The intake air may be introduced into the turbocharger 36 via a line 38, for compression purposes leading to a higher pressure thereof.

The compressed intake air from the turbocharger 36 flows towards an aftercooler 40, via a line 42. The aftercooler 40 is fluidly connected to the turbocharger 36, and is adapted to cool intake air received from the turbocharger 36. In the illustrated example, the aftercooler 40 is embodied as an Air to Air Aftercooler (ATAAC). Alternatively, the aftercooler 40 may embody an Air To Liquid Aftercooler (ATLAC). The intake air may then enter an intake air line 44 and further flow towards an intake plenum (not shown) of the air intake system 32, before being introduced into the intake manifold 30. The intake plenum may be fluidly coupled to the intake manifold 30 of the engine 26 and the intake air line 44.

The exhaust gases from the exhaust manifold 24 are introduced in the turbine “T” of the turbocharger 36, via a line 46. The exhaust gases provide driving force to the turbine “I” of the turbocharger 36. The engine system 18 also includes an exhaust system 48. The exhaust system 48 is in fluid communication with the turbocharger 36, via a line 47. The exhaust system 48 directs the exhaust gas flow out of the engine system 18. It is contemplated that the exhaust system 48 may include components such as, for example, particulate traps, NOx absorbers or other catalytic devices, attenuation devices, and other devices for treating and directing the exhaust gas flow out of the engine 26.

One of ordinary skill in the art will appreciate that when combustion temperatures may exceed approximately 1372° C., atmospheric nitrogen may react with oxygen, forming various oxides of nitrogen (NOx). In order to reduce the formation of NOx, an EGR process may be used to keep the combustion temperature below a NOx threshold. Therefore, a portion of the exhaust gas may be recirculated to the intake manifold 30 of the engine 6.

As shown in FIG. 2, the EGR system 22 includes an EGR line 50, The EGR line 50 is fluidly coupled between the intake manifold 30 and the exhaust manifold 24 of the engine 26. The EGR line 50 redirects some amount of the exhaust gases from the exhaust manifold 24 to the intake manifold 30. The EGR system 22 further includes an EGR valve 54. The EGR valve 54 is disposed in the EGR line 50. Further, the EGR system 22 includes a pressure line 56. The pressure line 56 is coupled between the intake manifold 30 and the EGR valve 54. It is contemplated that the EGR system 22 may include additional components (not shown) such as a catalyst, an electrostatic precipitation device, a shield gas system, one or more sensing elements, and other devices for redirecting of the exhaust gases, without any limitations.

In an example, the EGR valve 54 may be pneumatically controlled. The EGR valve 54 is in fluid communication with the EGR line 50. The EGR valve 54 selectively allows introduction of a metered amount of exhaust gases in to the intake manifold 30 of the engine 26 via a line 52. The EGR valve 54 is actuated based on an intake pressure communicated to the EGR valve 54, via the pressure line 56. The EGR valve 54 operates in an open position and a closed position. The EGR valve 54 is movable to the open position from the closed position, based on the intake pressure that is communicated to the EGR valve 54 via the pressure line 56. The pressure at the intake manifold 30 corresponds to a load on the engine 26.

In the open position, the EGR valve 54 allows fluid communication between the intake manifold 30 and the exhaust manifold 24 in order to introduce some amount of the exhaust gases in the intake manifold 30, via the line 52. In the closed position, the FOR valve 54 restricts fluid communication between the intake manifold 30 and the exhaust manifold 24.

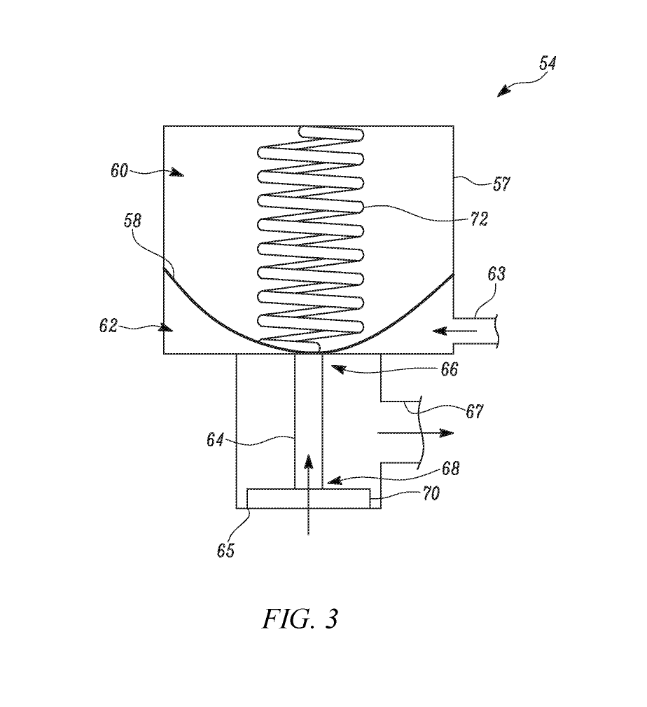

Referring to FIG. 3, a schematic view of the EGR valve 54 is shown. The EGR valve 54 includes a valve housing 57 and a valve diaphragm 58 disposed in the valve housing 57. The valve diaphragm 58 of the EGR valve 54 may include a rubberized or any other flexible body. The valve diaphragm 58 separates the interior of the valve housing 57 into a first valve compartment 60 and a second valve compartment 62. The first and second valve compartments 60, 62 are isolated from one another, to separately contain first and second valve compartment pressures. The position of the valve diaphragm 58 may vary as the relative pressure differential changes between the first valve compartment 60 and the second valve compartments 62. In an exemplary embodiment, the first valve compartment 60 is exposed to ambient environment so as to remain at ambient pressure and ambient temperature. The second valve compartment 62 is in fluid communication with the pressure line 56 (shown in FIG. 2, via a reference port 63.

Further, the EGR valve 54 includes an inlet port 65 and an outlet port 67. The inlet port 65 is in fluid communication with the exhaust manifold 24 of the engine 26, via the EGR line 50. The outlet port 67 is in fluid communication with the intake manifold 30 of the engine 26 via the line 52. The EGR valve 54 further includes a valve rod 64. The valve rod 64 includes a first end 66, and a second end 68 disposed opposite to the first end 66. The first end 66 of the valve rod 64 is connected to the valve diaphragm 58 of the EGR valve 54. Whereas, the second end 68 of the valve rod 64 includes a valve head 70. In a closed EGR valve 54. Further, in the open position of the EGR valve 54, the valve head 70 uncovers the inlet port 65 such that the inlet port 65 is in fluid communication with the outlet port 67. The valve rod 64 moves in response to movement of the valve diaphragm 58 to open and close the inlet port 65 of the EGR valve 54.

As shown in FIG. 3, the EGR valve 54 includes a spring 72. The spring 72 exerts a spring force against the valve rod 64. More particularly, the spring 72 is used to bias the valve diaphragm 58, and thereby the valve rod 64 and the valve head 70 in a closed configuration. In an example, the spring 72 is disposed in the first valve compartment 60. Alternatively, the spring 72 may be disposed in the second valve compartment 62 without limiting the scope of the present disclosure.

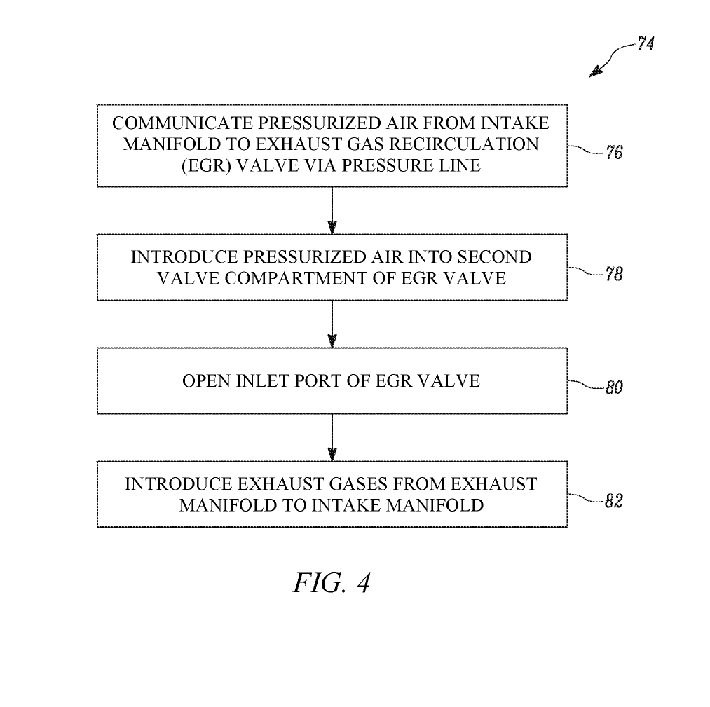

FIG. 4 illustrates a method 74 for recirculating some amount of the exhaust gases to the intake manifold 30, At step 76, the pressurized air from the intake manifold 30 is communicated to the EGR valve 54, via the pressure line 56. At step 78, the pressurized air flows into the second valve compartment 62 of the EGR valve 54, thereby pushing the valve diaphragm 58 upwards. At step 80, the inlet port 65 of the EGR valve 54 opens due to the upward movement of the valve diaphragm 58. More particularly, the upward movement of the valve diaphragm 58 causes the valve head 70 to move upwards thereby opening the inlet port 65. At step 82, some amount of the exhaust gases from the exhaust manifold 24 are introduced in the intake manifold 30, based on the communication between the inlet port 65 and the outlet port 67.

In the illustrated embodiment, the EGR valve 54 is positioned proximal to the intake manifold 30. Alternatively, the EGR valve 54 may be positioned proximal to the exhaust manifold 24, without limiting the scope of the present disclosure. It should be further noted that the EGR valve 54 may include any other type of valve that selectively allows introduction of the exhaust gases in the intake manifold 30.

### INDUSTRIAL APPLICABILITY

The EGR system 22 of the present disclosure may be applicable to a variety of applications requiring enhanced exhaust emissions control for efficient operation. The EGR valve 54 operates in the open position when the pressure at the intake manifold 30 is sufficient to require use of the EGR gases. The incorporation of the EGR valve 54 improves an overall durability of the engine 26. The EGR valve 54 is simple to control, and can be accommodated in a compact space, thereby reducing overall space claim of the engine system 18.

Further, as the EGR system 22 of the present disclosure eliminates the use of EGR. coolers, warranty issues from vibrations, high temperatures, pressures, and the like are reduced. The EGR system 22 disclosed herein includes fewer components and is a cost effective system for the recirculation of the exhaust gases.

While aspects of the present disclosure have been particularly shown and described with reference to the embodiments above, it will be understood by one skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An exhaust gas recirculation system comprising:
an engine having an intake manifold adapted to receive intake air from an aftercooler;
an exhaust manifold adapted to receive exhaust gas from a plurality of cylinders of the engine;
an exhaust gas recirculation (EGR) line fluidly coupled between the intake manifold and the exhaust manifold;
an EGR valve disposed in the EGR line; and
a pressure line coupled between the intake manifold and the EGR valve, wherein the EGR valve is movable to an open position from a closed position based on an intake pressure communicated to the EGR valve via the pressure line.
